(19) United States
(12) Patent Application Publication
(10) Pub. No.: US 2020/0114925 A1
(43) Pub. Date: Apr. 16, 2020

(54) INTERACTION DEVICE, INTERACTION METHOD, AND PROGRAM

(71) Applicant: HONDA MOTOR CO., LTD., Minato-ku, Tokyo (JP)

(72) Inventors: Shun Iwasaki, Wako-shi (JP); Hisao Asaumi, Wako-shi (JP); Kentaro Ishisaka, Wako-shi (JP); Izumi Kondo, Wako-shi (JP); Satoshi Koike, Wako-shi (JP); Tomohisa Manabe, Wako-shi (JP); Yo Ito, Tokyo (JP); Yuki Hayashi, Tokyo (JP)

(21) Appl. No.: 16/621,281

(22) PCT Filed: Jun. 14, 2018
(86) PCT No.: PCT/JP2018/022757

§ 371 Date: Dec. 11, 2019

(30) Foreign Application Priority Data
Jun. 16, 2017 (JP) 2017-118701

(51) Int. Cl. B60W 40/09; G06K 9/00; G05D 1/02

(52) U.S. Cl. CPC B60W 40/09; B60W 2040/0872; G05D 1/0212; G06K 9/00791

(57) ABSTRACT

An interaction device includes an acquisition unit that acquires recognition information of a user and a responding unit that responds to the recognition information acquired by the acquisition unit, and the responding unit derives an indicator indicating an emotional state of the user on the basis of the recognition information and determines a response content in a form based on the derived indicator.

### TECHNICAL FIELD

The present invention relates to an interaction device, an interaction method, and a program.

Priority is claimed on Japanese Patent Application No. 2017-118701, filed on Jun. 16, 2017, the contents of which are incorporated herein by reference.

### BACKGROUND

Robotic devices that communicate with users have been researched in recent years. For example, Patent Document 1 discloses a robotic device that expresses emotions on the basis of external circumstances such as words and behaviors of a user.

### RELATED ART DOCUMENTS

### Patent Documents

[Patent Document 1]

Japanese Unexamined Patent Application, First Publication No. 2017-077595

### SUMMARY OF INVENTION

### Problems to be Solved by the Invention

The robotic device disclosed in Patent Document 1 generates an emotion of the robotic device on the basis of a behavior of the user toward the robotic device, but the robotic device is not controlled in accordance with emotional states of a user.

The present invention has been achieved in consideration of the above circumstances and an objective thereof is to provide an interaction device, an interaction method, and a program that can estimate emotional states of a user and generate responses according to emotional states of the user.

### Means for Solving the Problem

An information processing device according to the invention employs the following configurations.

(1): An interaction device according to an aspect of the invention is an interaction device that includes an acquisition unit that acquires recognition information of a user, and a responding unit that responds to the recognition information acquired by the acquisition unit, in which the responding unit derives an indicator indicating an emotional state of the user based on the recognition information and determines a response content in a form based on the derived indicator.

(2): In the above aspect (1), the responding unit determines the response content based on a past history of a relation between the recognition information and the response content.

(3): In the above aspect (1) or (2), the responding unit derives, as the indicator, a degree of discomfort of the user based on the recognition information of the user with respect to the response.

(4): In any one of the above aspects (1) to (3), the responding unit derives, as the indicator, a degree of intimacy with the user based on the recognition information of the user with respect to the response.

(5): In any one of the above aspects (1) to (4), the responding unit allows the response content to vary.

(6): In any one of the above aspects (1) to (5), the responding unit derives the indicator for the response content based on a past history of the recognition information of the user with respect to the response and adjusts a parameter for deriving the indicator based on a difference between the derived indicator and an indicator for the actually acquired response content.

(7): An interaction method according to an aspect of the invention is an interaction method of a computer to acquire recognition information of a user, respond to the acquired recognition information, derive an indicator indicating an emotional state of the user based on the recognition information, and determine a response content in a form based on the derived indicator.

(8): A program according to an aspect of the invention is a program causing a computer to perform operations of acquiring recognition information of a user, responding to the acquired recognition information, deriving an indicator indicating an emotional state of the user based on the recognition information, and determining a response content in a form based on the derived indicator.

(9): An interaction device according to an aspect of the invention is an interaction device including an acquisition unit that acquires recognition information of a user and a responding unit that generates context information including information about a content of the recognition information by analyzing the recognition information acquired by the acquisition unit and determines a response content in accordance with an emotional state of the user based on the context information, in which the responding unit includes a context response generation unit that refers to a response history of the user corresponding to a response content generated based on past context information stored in a storage unit and generates a context response for responding to the user, and a response generation unit that calculates an indicator indicating an emotional state of the user changing depending on the response content and determines a new response content in a changed response form based on the context response generated by the context response generation unit and the indicator.

(10): In the above aspect (9), the response generation unit causes the determined response content to be stored in a response history storage unit of the storage unit as a response history in association with the context information, and the context response generation unit refers to the response history stored in the response history storage unit and generates a new context response for responding to the user.

(11): In the above aspect (9) or (10), the acquisition unit generates the recognition information obtained by acquiring data about a reaction of the user and digitizing the data and calculates a feature value based on a result of comparison of the recognition information with data learned in advance, and the responding unit analyzes the recognition information based on the feature value calculated by the acquisition unit and generates the context information.

### Advantage of the Invention

According to (1), (7), (8), and (9), it is possible to estimate an emotional state of a user and generate a response in accordance with the emotional state of the user.

According to (2), it is possible to predict a reaction of the user to a response content in advance and thus realize an intimate interaction with the user.

According to (3), (4), and (10), it is possible to change a response content and improve intimacy with the user by estimating an emotional state of the user.

According to (5), it is possible to prevent a state in which a response is not improved due to an indicator falling into a localized optimal solution from occurring in changing of the response so that a derived indicator moves in a preferred direction.

According to (6) and (11), in a case where there is a difference between a predicted emotional state of the user and an actually acquired emotional state of the user, a response content can be adjusted by feedback.

### BRIEF DESCRIPTION OF THE DRAWINGS

FIG. 1 is a diagram illustrating an example of a configuration of an interaction device 1.

FIG. 2 is a diagram illustrating examples of indicators derived by an estimation unit 13.

FIG. 3 is a diagram illustrating examples of indicators derived by the estimation unit 13.

FIG. 4 is a diagram illustrating an example of contents of task data 33 associated with states to be detected by a vehicle.

FIG. 5 is a diagram illustrating an example of information provided to a user U.

FIG. 6 is a flowchart showing an example of a flow of a process of the interaction device 1.

FIG. 7 is a diagram illustrating an example of a configuration of an interaction device 1A applied to a self-driving vehicle 100.

FIG. 8 is a diagram illustrating an example of a configuration of an interaction system S.

FIG. 9 is a diagram illustrating an example of a configuration of an interaction system SA.

FIG. 10 is a diagram illustrating an example of a detailed configuration of part of an interaction device 1 according to a modified example.

### DESCRIPTION OF THE EMBODIMENTS

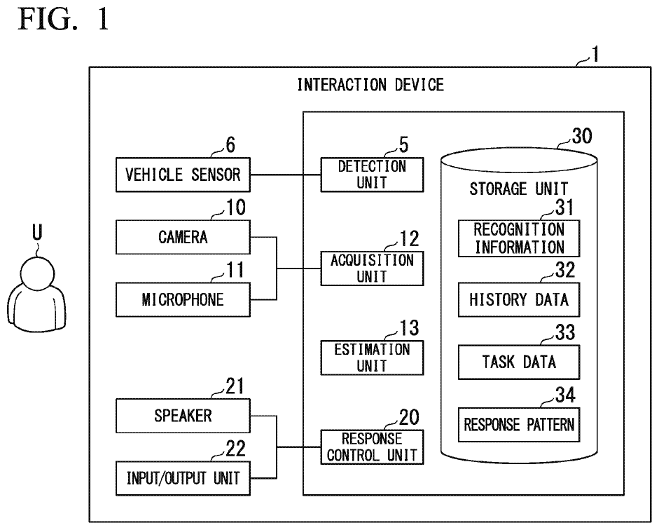

Embodiments of an interaction device of the present invention will be described below with reference to the drawings. FIG. 1 is a diagram illustrating an example of a configuration of an interaction device 1. The interaction device 1 is, for example, an information providing device mounted in a vehicle. The interaction device 1 detects information about the vehicle, for example, failures of the vehicle and provide the information to a user U.

### [Device Configuration]

The interaction device 1 includes, for example, a detection unit 5, a vehicle sensor 6, a camera 10, a microphone 11, an acquisition unit 12, an estimation unit 13, a response control unit 20, a speaker 21, an input/output unit 22, and a storage unit 30.

The storage unit 30 is realized by a hard disk drive (HDD) or a flash memory, a random access memory (RAM), a read only memory (ROM), and the like. The storage unit 30 stores, for example, recognition information 31, history data 32, task data 33, and response patterns 34.

Each of the acquisition unit 12, the estimation unit 13, and the response control unit 20 is realized by a processor such as a central processing unit (CPU) executing a program (software). In addition, some or all of the above-described functional units may be realized by hardware such as a large scale integration (LSI), an application specific integrated circuit (ASIC), a field-programmable gate array (FPGA), or a graphics processing unit (GPU) or may be realized in cooperation of software with hardware. Programs may be stored in advance in a storage device such as a hard disk drive (HDD) or a flash memory, or may be stored in a removable storage medium such as a DVD or a CD-ROM and installed in a storage device by loading the storage medium into a drive device (not illustrated). A combined unit of the estimation unit 13 and the response control unit 20 is an example of a “responding unit.”

The vehicle sensor 6 is a sensor provided in the vehicle and detects states such as failures of parts, wear thereof, lowering of liquid amounts, disconnections, and the like. The detection unit 5 detects states such as failures and wear that are occurring in the vehicle on the basis of detection results of the vehicle sensor 6.

The camera 10 is installed, for example, inside the vehicle and captures images of a user U. The camera 10 is a digital camera using a solid-state image sensor, for example, a charge coupled device (CCD), a complementary metal oxide semiconductor (CMOS), or the like. The camera 10 is attached to, for example, the rear-view mirror and acquires image data by imaging an area including the face of the user U. The camera 10 may be a stereo camera. The microphone 11 records, for example, audio data of voices of the user U. The microphone 11 may be built into the camera 10. Data acquired by the camera 10 and the microphone 11 is acquired by the acquisition unit 12.

The speaker 21 outputs sound. The input/output unit 22 includes, for example, a display device and displays images. In addition, the input/output unit 22 includes a touch panel, a switch, a key, and the like for receiving input operations performed by the user U. Information about task information is provided from the response control unit 20 via the speaker 21 and the input/output unit 22.

The estimation unit 13 derives an indicator indicating an emotional state of the user U on the basis of the recognition information 31.

The estimation unit 13 derives, for example, an indicator obtained by converting an emotion of the user U into discrete data on the basis of a facial expression or a voice of the user U.

Indicators include, for example, a degree of intimacy that the user U feels about a virtual responding subject of the interaction device 1 and a degree of discomfort indicating a sense of discomfort that the user U feels. Hereinbelow, a degree of intimacy will be represented by a plus sign and a degree of discomfort will be represented by a minus sign.

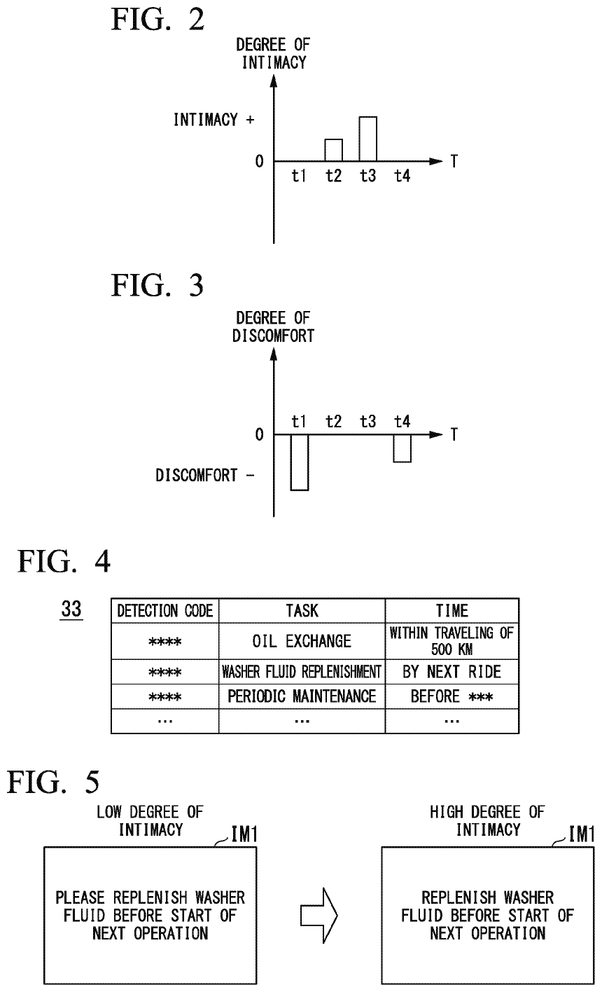

FIGS. 2 and 3 are diagrams illustrating examples of indicators derived by the estimation unit 13. The estimation unit 13 derives, for example, degrees of intimacy and discomfort of the user U on the basis of images of the user U of the recognition information 31. The estimation unit 13 acquires, as feature values, positions and sizes of the eyes and the mouth included in the acquired face image of the user U and converts the acquired feature values into parameters as numeric values indicating changes in a facial expression.

Furthermore, the estimation unit 13 interprets audio data of the voice of the user U of the recognition information 31 and converts the audio data into parameters as numeric values indicating changes in the voice. The estimation unit 13, for example, performs a fast Fourier transform (FFT) on waveform data of the voice to convert the voice into parameters through interpretation of waveform components. The estimation unit 13 may multiply each of the parameters by a coefficient to cause the parameters to be weighted. The estimation unit 13 derives a degree of intimacy and a degree of discomfort of the user U on the basis of the parameters of the facial expression and the parameters of the voice.

The response control unit 20 determines a task that the user U should act on, for example, on the basis of a change in a vehicle state detected by the detection unit 5. A task that the user U should act on is, for example, an instruction given to the user U when the vehicle detects any state. For example, when the detection unit 5 detects a failure on the basis of a detection result of the vehicle sensor 6, the response control unit 20 gives to the user U an instruction that the failed spot needs to be repaired.

Tasks are stored in the storage unit 30 in association with states to be detected by the vehicle as the task data 33. FIG. 4 is a diagram illustrating an example of details of the task data 33 associated with states to be detected by a vehicle.

The response control unit 20 determines a task corresponding to the detection result obtained from detection of the detection unit 5 with reference to the task data 33. The response control unit 20 generates task information about the task that the user U should act on in a time series manner. The response control unit 20 outputs information about the task information to the outside via the speaker 21 or the input/output unit 22. The information about the task information is a specific schedule associated with the task and the like. In a case where an instruction that a repair is necessary is given to the user U, for example, information about a specific repair method, repair request method, or the like is presented.

In addition, the response control unit 20 changes response contents on the basis of an emotional state estimated by the estimation unit 13. The response contents are the contents of the information provided to the user U via the speaker 21 and the input/output unit 22.

In a case where information is transmitted to the user U in, for example, an interactive form, the contents of information transmitted by the interaction device 1 are changed according to a degree of intimacy between the user U and the interaction device 1.

For example, if a degree of intimacy is high, information is transmitted in a friendly tone, and if a degree of intimacy is low, information is transmitted in polite language. In a case where a degree of intimacy is high, friendly talk such as chatting or the like may be added in addition to transmission of information. The response control unit 20 causes indicators indicating reactions of the user U to responses to be stored in the storage unit 30 as, for example, time-series history data 32.

### [Operation of Device]

Next, an operation of the interaction device 1 will be described. The detection unit 5 detects a state change such as a failure that has occurred in the vehicle or the like on the basis of a detection result of the vehicle sensor 6. The response control unit 20 provides a task that the user U should act on for the detected state change of the vehicle. The response control unit 20, for example, reads a task corresponding to the state of the vehicle from the task data 33 stored in the storage unit 30 and generates task information on the basis of the state of the vehicle detected by the detection unit 5.

The response control unit 20 outputs information about the task information to the outside via the speaker 21 or the input/output unit 22. First, the response control unit 20 gives, for example, a notification that there is information about the vehicle to the user U. At this moment, the response control unit 20 gives a notification that there is information in an interactive form and causes the user U to react.

The acquisition unit 12 acquires a facial expression or a reaction of the user U to the notification output from the response control unit 20 as recognition information 31. The estimation unit 13 estimates the emotional state of the user U on the basis of the recognition information 31 indicating the reaction of the user U to the response. In the estimation of the emotional state, the estimation unit 13 derives an indicator indicating the emotional state.

The estimation unit 13 derives, for example, a degree of intimacy and a degree of discomfort of the user U on the basis of the recognition information 31. The response control unit 20 changes the response contents made when information is provided on the basis of the level of the value of the indicator derived by the estimation unit 13.

The response control unit 20 determines the response contents on the basis of past history data 32 in which relations between indicators and response contents are stored in a time series manner. The response control unit 20 provides the information to the user U via the speaker 21 and the input/output unit 22 on the basis of the generated response contents. At this moment, the response control unit 20 changes the response on the basis of the degree of intimacy and the degree of discomfort of the user U estimated by the estimation unit 13 when the information about the task information is output.

The change of the response is made by the estimation unit 13 deriving a degree of intimacy and a degree of discomfort of the user, for example, on the basis of the recognition information 31 obtained by recognizing an action of the user U. Then, the response control unit 20 determines the response content in a form based on the derived indicator. FIG. 5 is a diagram illustrating an example of information provided to the user U. Response contents are changed according to levels of an indicator indicating a degree of intimacy as illustrated.

In addition, in a case where the absolute value of the degree of discomfort of the user U is higher than or equal to a reference value, the response control unit 20 changes the response content so that the level of discomfort is minimized. For example, in a case where a degree of discomfort of the user U is high, the response control unit 20 transmits information about task information in a polite tone to the user U in the next response. The response control unit 20 may give an apologetic response in a case where the absolute value of a degree of discomfort exceeds a threshold.

The response control unit 20 generates response content on the basis of response patterns 34 stored in the storage unit 30. The response patterns 34 are information in which responses corresponding to degrees of intimacy and degrees of discomfort of the user U are defined in predetermined patterns. Automatic responses by artificial intelligence may be made, rather than using the response patterns 34.

The response control unit 20 determines a response content according to a task on the basis of the response patterns 34 and presents the response content to the user U. The response control unit 20 may perform machine learning on the basis of the history data 32 and determine a response to the emotional state of the user U, without using the response patterns 34.

The response control unit 20 may allow a response content to vary. The variation refers to change in a response to one emotional state expressed by the user U, rather than deciding a uniform response content. By allowing the response content to vary, it is possible to prevent a state in which a response is not improved due to an indicator falling into a localized optimal solution from occurring in changing of the response so that a derived indicator moves in a preferred direction.

For example, in a case where a predetermined period has elapsed with a high degree of intimacy between the user U and the interaction device 1 according to a response content determined by the response control unit 20, there are cases where the response content determined by the response control unit 20 converges to a predetermined content and a degree of intimacy of the user U is maintained at a predetermined value.

Since the response control unit 20 changes the response so that the derived indicator moves in a preferred direction in the above-described state, the response control unit 20 allows the response content to vary and generates a response pattern so that a degree of intimacy becomes higher. In addition, the response control unit 20 may intentionally allow a response content to vary even in a case where a current degree of intimacy is determined to be high. By changing a response content as described above, it is likely to find a response pattern that increases a degree of intimacy.

In addition, the user U may be allowed to select or set a character according to his or her preference that will give responses of the interaction device 1 to interact with the character.

There may be a case where there is a difference between reactions of an emotional state and a predicted emotional state of the user U with respect to a response of the response control unit 20. In this case, the prediction of the emotional state may be adjusted on the basis of actually acquired recognition information of the user U. The estimation unit 13 predicts an emotional state of the user U and determines a response content on the basis of the past history data 32 of the recognition information 31 of the user U with respect to a response of the response control unit 20. The acquisition unit 12 acquires the recognition information 31 of a facial expression of the user U, or the like.

The estimation unit 13 compares the derived indicator with an indicator for the actually acquired response content on the basis of the recognition information 31, and in a case where there is a difference between the two indicators, parameters for deriving the indicator are adjusted. The estimation unit 13, for example, multiplies each of the parameters by a coefficient and adjusts the value of the indicator derived by adjusting the coefficient.

### [Process Flow]

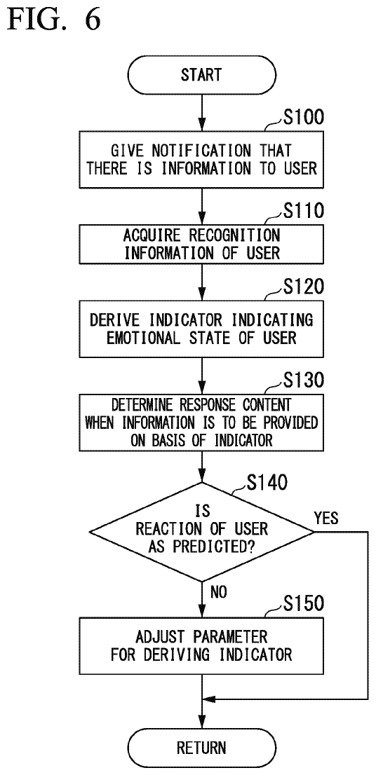

Next, the flow of a process of the interaction device 1 will be described. FIG. 6 is a flowchart showing an example of the flow of a process of the interaction device 1. The response control unit 20 gives a notification that there is a task that the user U should act on on the basis of a detection result obtained from detection of the detection unit 5 (Step S100). The acquisition unit 12 recognizes a reaction of the user U to the notification and acquires the recognition information 31 (Step S110). The estimation unit 13 derives an indicator indicating the emotional state of the user U on the basis of the recognition information 31 (Step S120).

The response control unit 20 determines a response content with respect to the user U when information is to be provided on the basis of the indicator (Step S130). The acquisition unit 12 recognizes a reaction of the user U to the response and acquires the recognition information 31, and the estimation unit 13 compares a predicted indicator with an indicator for an actually acquired response content and determines whether the reaction of the user U is as predicted according to whether there is a difference between the two indicators (Step S140). The estimation unit 13 adjusts parameters for deriving the indicator in the case where there is a difference between the two indicators (Step S150).

According to the above-described interaction device 1, it is possible to give a response with the response content according to the emotional state of the user U when information is to be provided. In addition, according to the interaction device 1, it is possible to create intimacy in providing information by deriving a degree of intimacy with the user U.

Furthermore, according to the interaction device 1, it is possible to create an interaction that makes the user U comfortable by deriving a degree of discomfort of the user U.

### Modified Example 1

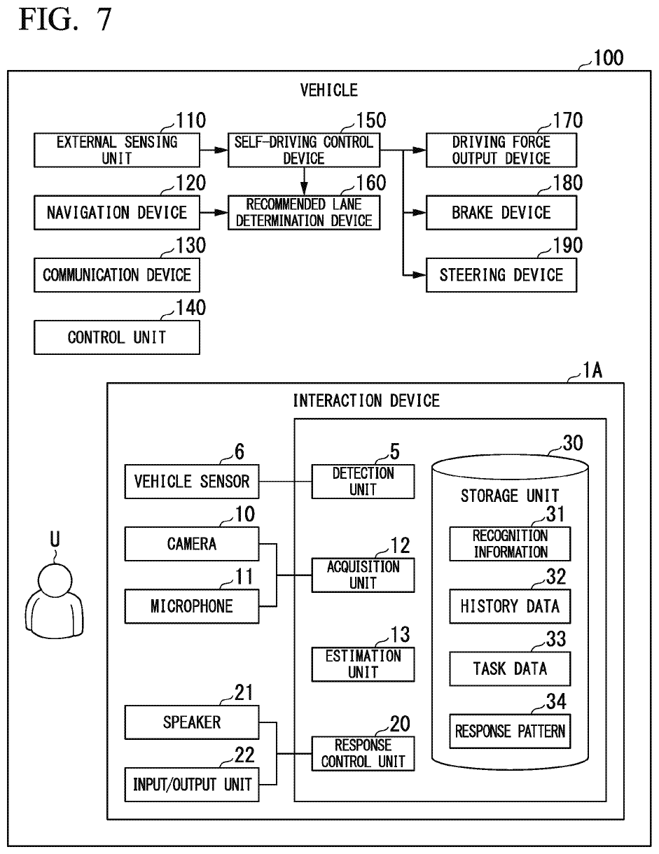

The above-described interaction device 1 may be applied to a self-driving vehicle 100. FIG. 7 is a diagram illustrating an example of a configuration of an interaction device 1A applied to the self-driving vehicle 100. Overlapping description will be appropriately omitted below by giving the same names and reference numerals to the same configurations as above.

A navigation device 120 outputs a route to a destination to a recommended lane determination device 160. The recommended lane determination device 160 refers to a map that is more detailed than map data of the navigation device 120, determines a recommended lane on which the vehicle will travel, and outputs the recommended lane to a self-driving control device 150. In addition, the interaction device 1A may be configured as a part of the navigation device 120.

The self-driving control device 150 controls some or all of a driving force output device 170 including the engine and motor, a brake device 180, and a steering device 190 such that the vehicle travels on the recommended lane input from the recommended lane determination device 160, on the basis of information input from an external sensing unit 110.

In the above-described self-driving vehicle 100, the user U has an increasing number of chances that he or she interacts with the interaction device 1A during self-driving. The interaction device 1A can help the user U comfortably spend time in the self-driving vehicle 100 by increasing a degree of intimacy with the user U.

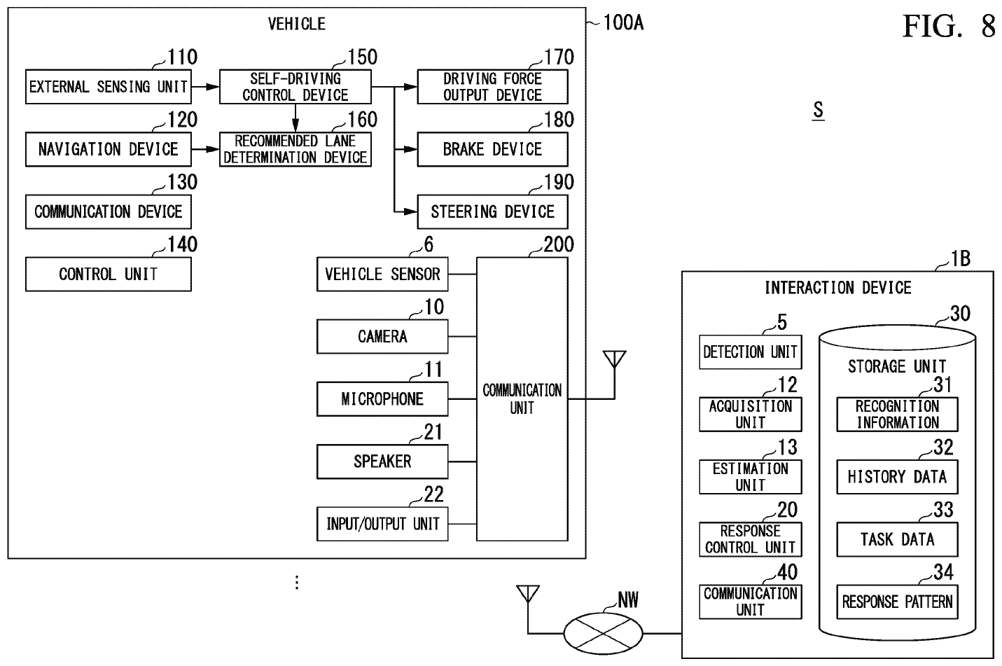

An interaction system S may be configured by configuring the above-described interaction device 1 as a server. FIG. 8 is a diagram illustrating an example of a configuration of an interaction system S.

The interaction system S includes a vehicle 100A and an interaction device 1B that communicates with the vehicle 100A via a network NW. The vehicle 100A performs wireless communication and communicates with the interaction device 1B via the network NW.

The vehicle 100A has each of devices including a vehicle sensor 6, a camera 10, a microphone 11, a speaker 21, and an input/output unit 22, and these devices are connected to a communication unit 200.

The communication unit 200 performs wireless communication using, for example, a cellular network or a Wi-Fi network, Bluetooth (registered trademark), Dedicated Short-Range Communication (DSRC), or the like to communicate with the interaction device 1B via the network NW.

The interaction device 1B includes a communication unit 40 to communicate with the vehicle 100A via the network NW. The interaction device 1B communicates with the vehicle sensor 6, the camera 10, the microphone 11, the speaker 21, and the input/output unit 22 through the communication unit 40 to input and output information. The communication unit 40 includes, for example, a network interface card (NIC).

According to the above-described interaction system S, by configuring the interaction device 1B as a server, not only one vehicle but also a plurality of vehicles can be connected to the interaction device 1B.

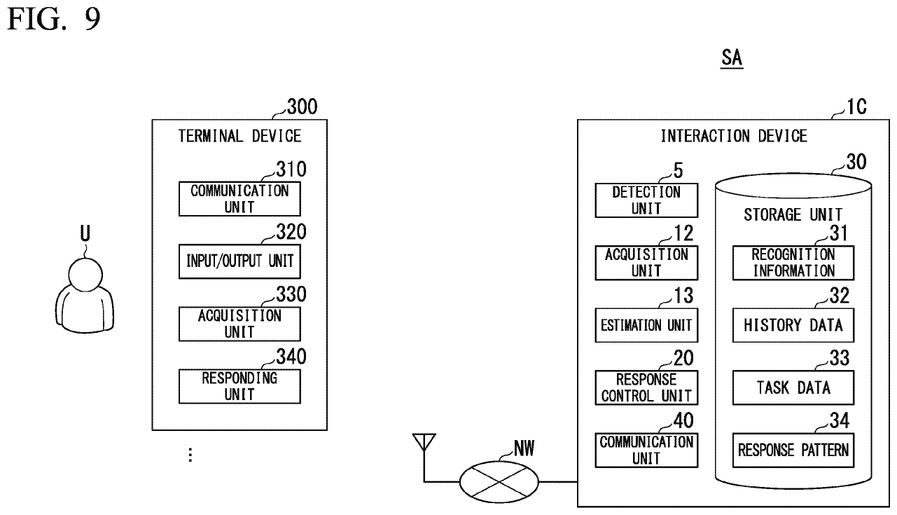

Services provided by the above-described interaction device may be offered by a terminal device such as a smartphone. FIG. 9 is a diagram illustrating an example of a configuration of an interaction system SA.

The interaction system SA includes a terminal device 300 and an interaction device 1C that communicates with the terminal device 300 via a network NW. The terminal device 300 performs wireless communication to communicate with the interaction device 1C via the network NW.

In the terminal device 300, an application program, a browser, or the like for using services provided by the interaction device is activated and the services described below are supported. The following description will be provided on the premise that the terminal device 300 is a smartphone and an application program is being activated.

The terminal device 300 is, for example, a smartphone or a tablet terminal, a personal calculator, or the like. The terminal device 300 includes, for example, a communication unit 310, an input/output unit 320, an acquisition unit 330, and a responding unit 340.

The communication unit 310 performs wireless communication using, for example, a cellular network or a Wi-Fi network, Bluetooth (registered trademark), DSRC, (or the like to communicate with the interaction device 1B via a network NW.

The input/output unit 320 includes, for example, a touch panel and a speaker. The acquisition unit 330 includes a camera that is included in the terminal device 300 and images the user U and a microphone.

The responding unit 340 is realized by a processor such as a central processing unit (CPU) executing a program (software). In addition, the above-described functional units may be realized by hardware such as a large-scale integration (LSI) or an application specific integrated circuit (ASIC), a field-programmable gate array (FPGA), or a graphics processing unit (GPU) or realized by cooperation of software with the hardware.

The responding unit 340 transmits, for example, information acquired by the acquisition unit 330 to the interaction device 1C via the communication unit 310. The responding unit 340 provides a response content received from the interaction device 1C to the user U via the input/output unit 320.

With the above-described configuration, the terminal device 300 can give a response with the response content according to an emotional state of the user U when information is to be provided. In addition, the terminal device 300 in the interaction system SA may acquire information of a vehicle state by communicating with the vehicle and provide the information about the vehicle.

According to the above-described interaction system SA, when information is provided to the user U by the terminal device 300 communicating with the interaction device 1C, an emotional state of the user U can be estimated and a response according to the emotional state of the user can be generated.

### Modified Example 2

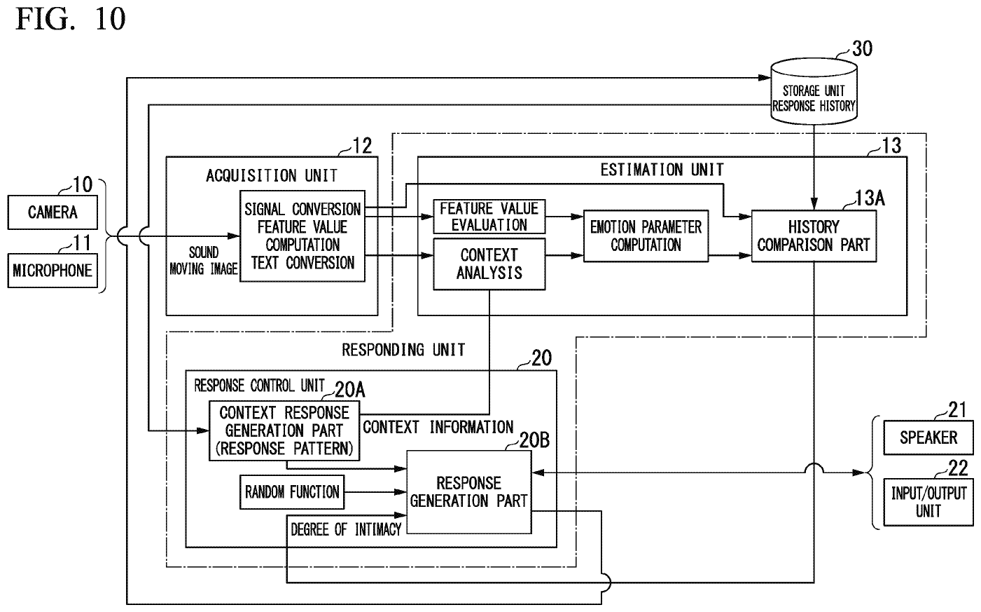

The above-described interaction device 1 may change information to be referred to according to attributes of contents of an interaction with a user and generate response contents. Overlapping description will be omitted below by giving the same names and reference numerals to the same configurations as those of the above embodiments. FIG. 10 is a diagram illustrating an example of a detailed configuration of a part of an interaction device 1 according to a modified example 2. In FIG. 10, for example, an example of the flow of data, processing between an acquisition unit 12, a responding unit (an estimation unit 13 and a response control unit 20), and a storage unit 30 of the interaction device 1 is described.

The estimation unit 13 includes, for example, a history comparison part 13A. The response control unit 20 includes, for example, a context response generation part 20A and a response generation part 20B.

The acquisition unit 12 acquires, for example, data on reactions of a user from a camera 10 and a microphone 11. The acquisition unit 12 acquires, for example, image data obtained by imaging the user U and audio data including responses of the user U. The acquisition unit 12 converts signals of the acquired image data and audio data and generates recognition information 31 including information obtained by digitizing the images and sounds.

The recognition information 31 includes information of, for example, feature values based on the sounds, text data obtained by converting the sound contents into text, feature values based on the images, and the like. Each feature value and context attributes will be described below.

The acquisition unit 12 causes, for example, a text converter or the like to recognize audio data to convert sounds into text data for each phrase. The acquisition unit 12 calculates, for example, feature values based on the acquired image data. The acquisition unit 12, for example, extracts feature points such as contours and edges of an object based on luminance differences between the pixels of the images and recognizes the object on the basis of the extracted feature points.

The acquisition unit 12 extracts feature points of, for example, contours of the face, the eyes, the nose, the mouth, and the like of the user U on the images, compares the feature points on the plurality of images, and thereby recognizes motions of the face of the user U. The acquisition unit 12 extracts feature values (vectors), for example, by comparing data sets learned by a neural network or the like in advance for motions of the faces of humans with the acquired image data. The acquisition unit 12 calculates the feature values including parameters of, for example, a “motion of the eyes,” a “motion of the mouth,” “laughter,” “no facial expression,” “angry,” and the like on the basis of the changes in the eyes, the nose, the mouth, and the like.

The acquisition unit 12 generates recognition information 31 including context information, which will be described below, generated on the basis of text data and information of feature values based on the image data. The recognition information 31 is information obtained by associating, for example, feature values based on text converted data and image data with data of sounds and display output by the interaction device 1.

For example, in a case where the interaction device 1 issues a notification encouraging maintenance, the acquisition unit 12 generates the recognition information 31 in association with text data of the sound coming from the user U in response to the notification and feature values of the facial expression of the user U of that time. The acquisition unit 12 may generate data of the loudness [dB] of the sound coming from the user U on the basis of audio data and add the data to the recognition information 31. The acquisition unit 12 outputs the recognition information 31 to the estimation unit 13.

The estimation unit 13 evaluates the feature values on the basis of the recognition information 31 acquired from the acquisition unit 12 and digitizes the emotion of the user U. The estimation unit 13 extracts vectors of the feature values of the facial expression of the user U based on the image data corresponding to the notification issued by the interaction device 1, for example, on the basis of the recognition information 31.

The estimation unit 13 analyzes, for example, the text data included in the recognition information 31 to perform context analysis of the contents of talks of the user. The context analysis calculates contents of talks as parameters that can be processed mathematically.

The estimation unit 13 compares, for example, data sets learned by a neural network or the like in advance with the text data on the basis of the contents of the text data, classifies the meanings of the interactive contents, and determines context attributes on the basis of the detailed meanings.

The context attributes are numeric values that can be processed mathematically expressing, for example, whether categorized interaction contents such as “vehicle,” “route search,” “surroundings information,” and the like correspond to each of a plurality of categories. The estimation unit 13 extracts, for example, words included in the interaction contents such as “failure,” “sensor defect,” or “repair” on the basis of the contents of the text data, compares the extracted words with the data sets learned in advance, calculates attribute values, and determines a context attribute of the interaction content as “vehicle” on the basis of the magnitude of the attribute values.

The estimation unit 13 calculates, for example, an evaluation value indicating a level of each parameter that is an evaluation item for the context attributes on the basis of the contents of the text data. The estimation unit 13 calculates, for example, feature values of the interaction contents such as “maintenance,” “failure,” “operation,” and “repair” related to “vehicle” on the basis of the text data. For example, if an interaction content is “maintenance” as a feature value of the interaction content, the acquisition unit 12 calculates feature values for parameters learned in advance such as “exchange of consumables, etc.,” “maintenance place,” or “part to be replaced” related to details of maintenance on the basis of the interaction content.

The estimation unit 13 generates context information by associating the feature values based on the calculated text data with the context attributes and outputs the context information to the context response generation part 20A of the response control unit 20. A process of the context response generation part 20A will be described below.

The estimation unit 13 further calculates feature values of an emotion of the user U from response contents of the user U on the basis of the text data. The estimation unit 13 extracts, for example, an ending word, a call word, and the like in a talk coming from the user U and calculates feature values of the emotions of the user U such as “intimate,” “normal,” “uncomfortable,” “unsatisfied,” or the like.

The estimation unit 13 calculates emotion parameters serving as indicator values of emotions of the user U on the basis of the feature values of the emotions of the user U based on images and the result of context analysis. The emotion parameters are, for example, indicator values of a plurality of classified emotions such as delight, anger, sadness, joy, and the like. The estimation unit 13 estimates emotions of the user U on the basis of the calculated emotion parameters. The estimation unit 13 may calculate indexes of a degree of intimacy, a degree of discomfort, and the like obtained by digitizing emotions on the basis of the calculated emotion parameters.

The estimation unit 13 inputs, for example, a vector of a feature value to an emotion evaluation function and calculates an emotion parameter using a neural network. The emotion evaluation function helps learning, as teacher data, a number of input vectors and the emotion parameter of the correct answer of that time in advance and thereby the computation result corresponding to the correct answer is maintained. The emotion evaluation function is configured to output an emotion parameter on the basis of a degree of similarity between the vector of a newly input feature value and the correct answer. The estimation unit 13 calculates a degree of intimacy between the user U and the interaction device 1 on the basis of the size of the vector of the emotion parameter.

The history comparison part 13A adjusts the calculated degree of intimacy by comparing it with a response history of response contents generated in the past. The history comparison part 13A acquires, for example, a response history stored in the storage unit 30. The response history refers to past history data 32 with respect to reactions of the user U to response contents generated by the interaction device 1.

The history comparison part 13A compares the calculated degree of intimacy, the recognition information 31 acquired from the acquisition unit 12, and the response history and adjusts the degree of intimacy according to the response history. The history comparison part 13A compares, for example, the recognition information 31 with the response history and adjust the degree of intimacy with the user U by adding or subtracting a degree of intimacy according to the progress of a degree of intimacy. The history comparison part 13A, for example, refers to the response history and changes the degree of intimacy indicating the emotional state of the user changing depending on a context response. The history comparison part 13A outputs the adjusted degree of intimacy to the response generation part 20B. The degree of intimacy may be changed depending on settings by the user U.

Next, a process of the response control unit 20 will be described. The response control unit 20 determines a response content to the user on the basis of an analysis result.

The context response generation part 20A acquires context information output from the estimation unit 13. The context response generation part 20A refers to a response history corresponding to the context information stored in the storage unit 30 on the basis of the context information. The context response generation part 20A extracts a response corresponding to the content of talk of the user U from the response history and generates a context response serving as a response pattern for responding to the user U. The context response generation part 20A outputs the context response to the response generation part 20B.

The response generation part 20B determines a response content in a changed response form on the basis of the context response generated by the context response generation part 20A and the degree of intimacy acquired from the history comparison part 13A. At this time, the response generation part 20B may intentionally allow variation of the response content using a random function.

The response generation part 20B causes the determined response content to be stored in a response history storage unit of the storage unit 30 in association with the context information. Then, the context response generation part 20A refers to a new response history stored in the response history storage unit and generates a new context response for responding to the user.

According to the interaction device 1 of the above-described modified example 2, a more appropriate response content can be output by changing the response history to be referred to according to attributes of contents of talk of the user U. According to the interaction device 1 of the modified example 2, recognition accuracy can be improved for fewer parameters by reflecting an interpretation result of the recognition information 31 in addition to a temporary computation result.

Although embodiments for implementing the present invention has been described, the present invention is not limited to the embodiments at all and can be variously modified and substituted within a scope not departing from the gist of the present invention. For example, the above-described interaction device may be applied to a manual driving vehicle. In addition, the interaction device 1 may be used as an information providing device that provides and manages information about a route search, a surroundings information search, schedule management, and the like in addition to providing information about the vehicle. The interaction device 1 may acquire information from a network and may be linked with a navigation device.

What is claim is:

1.-11. (canceled)

12. An interaction device comprising:
an acquisition unit that acquires recognition information of a user with respect to a change in a state of a device detected by a detection unit; and
a responding unit that responds to the recognition information acquired by the acquisition unit,
wherein the responding unit derives an indicator indicating an emotional state of the user based on the state and the recognition information and determines a response content in a form based on the derived indicator.

13. The interaction device according to claim 12,
wherein the responding unit determines the response content based on a past history of a relation between the recognition information and the response content.

14. The interaction device according to claim 12,
wherein the responding unit derives, as the indicator, a degree of discomfort of the user based on the recognition information of the user with respect to the response.

15. The interaction device according to claim 12,
wherein the responding unit derives, as the indicator, a degree of intimacy with the user based on the recognition information of the user with respect to the response.

16. The interaction device according to claim 12,
wherein the responding unit allows the response content to vary.

17. The interaction device according to claim 12,
wherein the responding unit derives the indicator for the response content based on a past history of the recognition information of the user with respect to the response and adjusts a parameter for deriving the indicator based on a difference between the derived indicator and an indicator for the actually acquired response content.

18. An interaction method of a computer to:
detect a change in a state of a device;
acquire recognition information of a user with respect to the state of the device;
respond to the acquired recognition information;
derive an indicator indicating an emotional state of the user based on the state and the recognition information; and
determine a response content in a form based on the derived indicator.

19. A program causing a computer to perform operations of:
detecting a change in a state of a device;
acquiring recognition information of a user with respect to the state of the device;
responding to the acquired recognition information;
deriving an indicator indicating an emotional state of the user based on the state and the recognition information; and
determining a response content in a form based on the derived indicator.

20. An interaction device comprising:
an acquisition unit that acquires recognition information of a user with respect to a change in a state of a device detected by a detection unit; and
a responding unit that generates context information including information about a content of the recognition information by analyzing the state of the device and the recognition information acquired by the acquisition unit and determines a response content in accordance with an emotional state of the user based on the context information,
wherein the responding unit includes a context response generation unit that refers to a response history of the user corresponding to a response content generated based on past context information stored in a storage unit and generates a context response for responding to the user, and a response generation unit that calculates an indicator indicating an emotional state of the user changing depending on the response content and determines a new response content in a changed response form based on the context response generated by the context response generation unit and the indicator.

21. A vehicle control method of an in-vehicle computer to:
recognize a position of a neighboring vehicle of a vehicle;
generate a plurality of trajectory candidates based on the recognized position of the neighboring vehicle, and
cause a display unit to display both an image showing a trajectory on which the vehicle can travel and an image showing a trajectory on which the vehicle is not able to travel among the plurality of generated trajectory candidates.

22. The interaction device according to claim 20,
wherein the acquisition unit generates the recognition information obtained by acquiring data about a reaction of the user and digitizing the data and calculates a feature value based on a result of comparison of the recognition information with data learned in advance, and
wherein the responding unit analyzes the recognition information based on the feature value calculated by the acquisition unit and generates the context information.
